(19) United States
(12) Patent Application Publication
(10) Pub. No.: US 2017/0052723 A1
(43) Pub. Date: Feb. 23, 2017

(54) REPLICATING DATA USING REMOTE DIRECT MEMORY ACCESS (RDMA)

(71) Applicant: HEWLETT PACKARD ENTERPRISE DEVELOPMENT LP, Houston, TX (US)

(72) Inventor: Douglas L. Voigt, Boise, ID (US)

(21) Appl. No.: 15/305,478

(22) PCT Filed: Jun. 10, 2014
(86) PCT No.: PCT/US14/41741

§ 371 Date: Oct. 20, 2016

(51) Int. Cl. G06F 3/06; G06F 15/173; G06F 13/28

(52) U.S. Cl. CPC G06F 3/0619; G06F 13/28; G06F 3/065; G06F 3/0679; G06F 3/0659; G06F 15/17331; G06F 2206/1014

(57) ABSTRACT

Example implementations relate to replicating data using remote directory memory access (RDMA). In example implementations, addresses may be registered in response to a map command. Data may be replicated using an RDMA.

### BACKGROUND

An application may use virtual addresses to read data from and write data to a volatile cache. A primary copy of data written to the volatile cache may be stored in a local non-volatile memory. Virtual addresses used by the application may correspond to respective physical addresses of the local non-volatile memory.

### BRIEF DESCRIPTION OF THE DRAWINGS

The following detailed description references the drawings, wherein:

FIG. 1 is a block diagram of an example device that includes a machine-readable storage medium encoded with instructions to register addresses in response to a map command;

FIG. 2 is a block diagram of an example device that includes a machine-readable storage medium encoded with instructions to enable enforcement of a recovery point objective;

FIG. 3 is a block diagram of an example device that includes a machine-readable storage medium encoded with instructions to enable tracking of completion of a remote synchronization of data;

FIG. 4 is a block diagram of an example system that enables registration of addresses in response to a map command;

FIG. 5 is a block diagram of an example system for enforcing an order in which data is replicated in a remote storage entity;

FIG. 6 is a block diagram of an example system for remote synchronization of data:

FIG. 7 is a flowchart of an example method for registering addresses for a remote direct memory access:

FIG. 8 is a flowchart of an example method for replicating data in a remote storage entity; and

FIG. 9 is a flowchart of an example method for enforcing a recovery point objective.

### DETAILED DESCRIPTION

An application running on an application server may write data to a volatile cache, and may store a local copy of the data in a non-volatile memory of the application server. A remote copy of the data may be stored in a non-volatile memory of a remote location, such as a storage server. Data may be transferred from the application server to the remote server using a remote direct memory access (RDMA). RDMAs may reduce CPU overhead in a data transfer, but may have long latency times compared to memory access. Initiating an RDMA each time a local copy of data is made, and waiting for an RDMA to be completed before writing additional data to a volatile cache, may consume more time and resources than are saved by using RDMA for data transfer. In light of the above, the present disclosure provides for registering addresses in response to a map command, reducing RDMA latency time. In addition, the present disclosure enables an application to accumulate data from multiple local write operations before initiating an RDMA, reducing the number of RDMAs used to transfer data to a remote location.

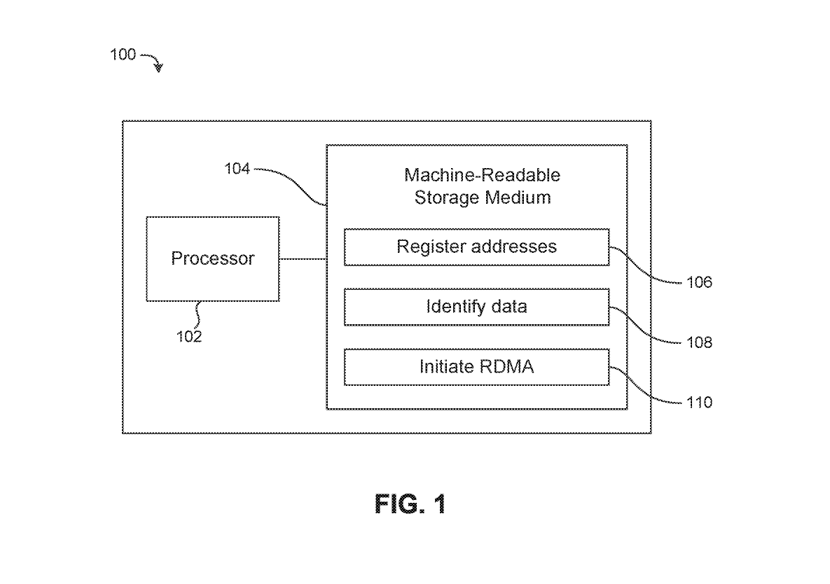

Referring now to the drawings, FIG. 1 is a block diagram of an example device 100 that includes a machine-readable storage medium encoded with instructions to register addresses in response to a map command. As used herein, the terms “include”, “have”, and “comprise” are interchangeable and should be understood to have the same meaning. In some implementations, device 100 may operate as and/or be part of an application server, In FIG. 1, device 100 includes processor 102 and machine-readable storage medium 104.

Processor 102 may include a central processing unit (CPU), microprocessor (e.g., semiconductor-based microprocessor), and/or other hardware device suitable for retrieval and/or execution of instructions stored in machine-readable storage medium 104. Processor 102 may fetch, decode, and/ or execute instructions 106, 108, and 110. As an alternative or in addition to retrieving and/or executing instructions, processor 102 may include an electronic circuit comprising a number of electronic components for performing the functionality of instructions 106, 108, and/or 110.

Machine-readable storage medium 104 may be any suitable electronic, magnetic, optical, or other physical storage device that contains or stores executable instructions. Thus, machine-readable storage medium 104 may include, for example, a RAM, an Electrically Erasable Programmable Read-Only Memory (EEPROM), a storage device, an optical disc, and the like. In some implementations, machine-readable storage medium 104 may include a non-transitory storage medium, where the term “non-transitory” does not encompass transitory propagating signals. As described in detail below, machine-readable storage medium 104 may be encoded with a set of executable instructions 106, 108, and 110.

Instructions 106 may register, in response to a map command, a first plurality of virtual addresses specified by the map command. The map command may be issued by an application running on an application server, and may cause each of the first plurality of virtual addresses to be assigned to a respective physical address of a non-volatile memory (NVM) of the application server. As used herein, the term “non-volatile memory”, abbreviated “NVM”, should be understood to refer to a memory that retains stored data even when not powered. The application may use the first plurality of virtual addresses to access data on a volatile memory of the application server. Data that the application writes to one of the first plurality of virtual addresses may also be written to a location corresponding to the respective physical address of the NVM of the application server, so that a local copy of the data may be obtained in case power to the application server is lost.

A copy of the data may also be made at a remote storage entity, so that a copy of the data may be obtained in the event that a local copy of the data is corrupted or lost. As used herein, the term “remote storage entity” should be understood to refer to an entity that stores data and is different from the entity from which a map command originates. For example, a map command may originate on an application server, which may include an NVM in which copies of data may be locally stored. Copies of the data may also be stored in an NVM of a remote storage entity, which may be a storage server. The act of storing copies of data in a remote storage entity may be referred to herein as “replicating” data.

The registering of the first plurality of virtual addresses may lead to the first plurality of addresses being transmitted to a remote storage entity, which may generate a second plurality of virtual addresses to be used for RDMAs of an NVM of the remote storage entity. RDMAs may be used to transfer data to the remote storage entity so that CPU overhead for replicating data may be minimized. In some implementations, the second plurality of virtual addresses may be generated by a network adaptor on the remote storage entity. In some implementations, the second plurality of virtual addresses may be generated by a local network adaptor (e.g., on an application server). A network adaptor may generate a separate set of virtual addresses for each map command. While the first plurality of virtual addresses are registered, the first plurality of virtual addresses, as well as addresses of the NVM of the remote storage entity where data is replicated, may be pinned to prevent an operating system (OS) from modifying or moving data stored at those addresses.

Sync commands may be issued by an application running on an application server. Data stored at a virtual address specified by a sync command is referred to herein as being “associated with” the sync command. In response to a sync command, the data associated with the sync command may be stored in an NVM of the application server. For example, in response to a sync command, a volatile cache or buffer on the application server may be flushed to an NVM of the application server so that a local copy of data that is in the volatile cache/buffer may be created in the NVM of the application server. In some implementations, a sync command may specify multiple virtual addresses, a range of virtual addresses, or multiple ranges of virtual addresses. Each sync command may include a boundary indication at the end of the last address in the respective sync command.

Although data associated with a sync command may be replicated immediately after the sync command is executed, resources (e.g., time and processing power used to register addresses and establish an RDMA connection) may be used more efficiently if multiple sync commands are executed before the data associated with the sync commands are replicated in a remote storage entity. Instructions 108 may identify data associated with a plurality of sync commands that specify any of the first plurality of virtual addresses. In some implementations, instructions 108 may copy data associated with the plurality of sync commands to a data structure that is used to accumulate data to be replicated. In some implementations, instructions 108 may set a replication bit of a page, in a page table, that includes data associated with any of the plurality of sync commands,

The plurality of sync commands may all be executed (e.g., data associated with the plurality of sync commands may be copied to an NVM on an application server) before data associated with the plurality of sync commands is replicated. The data associated with the plurality of sync commands may be replicated in response to a remote synchronization (rsync) command. An rsync command may cause the replication of all data associated with any of the sync commands issued after the previous rsync command. An application server may not transmit an rsync command to a remote storage entity if execution of a sync command on the application server has not been completed (e.g., if data flushed from a volatile cache of the application server in response to a sync command has not yet reached an NVM of the application server); the application server may wait until execution of all outstanding sync commands have been completed before transmitting an rsync command. Execution of an rsync command may produce an application consistency point, at which an up-to-date copy of data in volatile memory exists in a local NVM (e.g., an NVM of an application server) as well as in a remote NVM (e.g., an NVM of a storage server). In response to an rsync command, volatile caches/buffers of a remote storage entity may be flushed to an NVM of the remote storage entity.

Instructions 110 may initiate, in response to an rsync command, a remote direct memory access (RDMA) to replicate, in accordance with boundary indications in the plurality of sync commands, the identified data in a remote storage entity. In implementations where a data structure is used to accumulate data to be replicated, the rsync command may cause data in the data structure to be transferred to the remote storage entity using the RDMA. In implementations where replication bits are used, the rsync command may cause data, in pages whose respective replication bits are set, to be transferred to the remote storage entity using the RDMA. The replication bits may be reset after such data is transferred. In some implementations, multiple RDMAs may be used to transfer the identified data to the remote storage entity.

The identified data may be transferred with virtual addresses, of the second plurality of virtual addresses, that may be used to determine in which locations in the remote storage entity the identified data is to be replicated. The boundary indications in the plurality of sync commands may be used to group such virtual addresses in the same way, during the RDMA(s), as addresses of the first plurality of virtual addresses were grouped by the plurality of sync commands. Thus, the boundary indications may be used to ensure that the identified data is grouped in the same way in the remote storage entity as in an NVM of the application server (i.e., that a remote copy of the identified data is identical to a local copy on the application server). In some implementations, the identified data may be replicated in a memristor-based NVM of the remote storage entity. For example, the identified data may be replicated in a resistive random-access memory (ReRAM) on a storage server,

In some implementations, an RDMA may be used to replicate data, that is associated with a sync command issued alter a first rsync command, before the next rsync command is transmitted to a remote storage entity. Data that is associated with a sync command issued between a first rsync command and a second rsync command, and that is replicated before the second rsync command is transmitted to a remote storage entity, may be tracked to ensure that such data is not transferred to the remote storage entity again in response to the second rsync command. For example, such data may not be copied to the data structure discussed above with respect to instructions 108, or a replication bit of a page that includes such data may not be set.

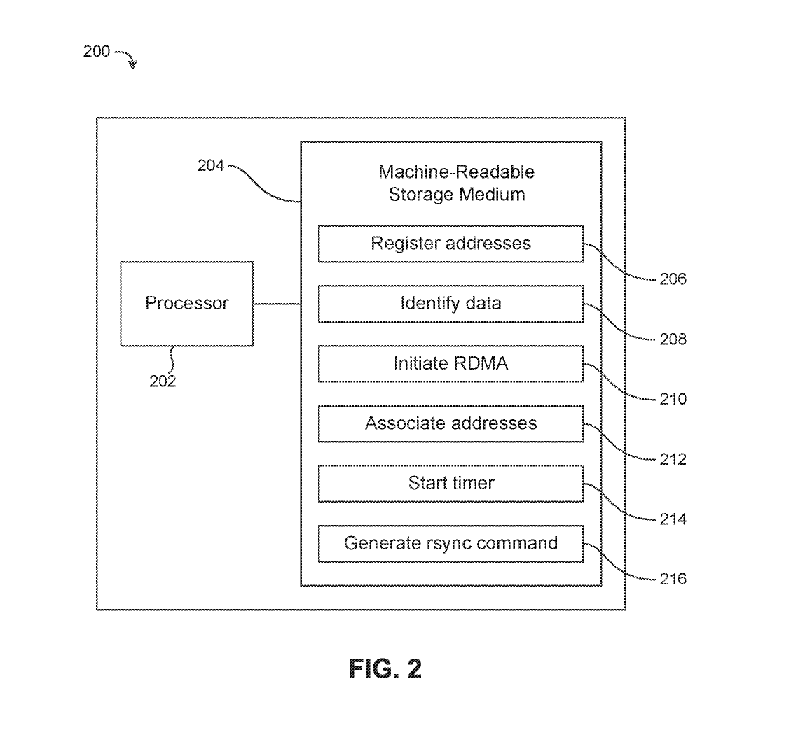

FIG. 2 is a block diagram of an example device 200 that includes a machine-readable storage medium encoded with instructions to enable enforcement of a recovery point objective. In some implementations, device 200 may operate as and/or be part of an application server. In FIG. 2, device 200 includes processor 202 and machine-readable storage medium 204.

As with processor 102 of FIG. 1, processor 202 may include a CPU, microprocessor (e.g., semiconductor-based microprocessor), and/or other hardware device suitable for retrieval and/or execution of instructions stored in machine-readable storage medium 204. Processor 202 may fetch, decode, and/ or execute instructions 206, 208, 210, 212, 214, and 216 to enable enforcement of a recovery point objective, as described below. As an alternative or in addition to retrieving and/or executing instructions, processor 202 may include an electronic circuit comprising a number of electronic components for performing the functionality of instructions 206, 208, 210, 212, 214, and/or 216.

As with machine-readable storage medium 104 of FIG. 1, machine-readable storage medium 204 may be any suitable physical storage device that stores executable instructions. Instructions 206, 208, and 210 on machine-readable storage medium 204 may be analogous to (e.g., have functions and/or components similar to) instructions 106, 108, and 110 on machine-readable storage medium 104. Instructions 206 may register, in response to a map command, a first plurality of virtual addresses specified by the map command. Instructions 208 may identify data associated with a plurality of sync commands that specify any of the first plurality of virtual addresses. Instructions 212 may associate each of a second plurality of virtual addresses with a respective one of the first plurality of virtual addresses. The second plurality of virtual addresses may be generated by a network adaptor locally or on a remote storage entity, as discussed above with respect to FIG. 1. The identified data may be replicated in memory locations, of a remote storage entity, that correspond to respective ones of the second plurality of virtual addresses associated with respective ones of the first plurality of virtual addresses specified by the plurality of sync commands.

An application server may receive the second plurality of virtual addresses from the remote storage entity (e.g., from a network adaptor on the remote storage entity) and store the virtual address pairs. Based on the stored virtual address pairs, virtual addresses, of the second plurality of virtual addresses, that correspond to virtual addresses, of the first plurality of virtual addresses, specified by the plurality of sync commands may be determined. The determined virtual addresses of the second plurality of virtual addresses may be used to specify where data transferred using an RDMA (e.g., data associated with the plurality of sync commands) is to be replicated in a remote storage entity in response to an rsync command.

Instructions 214 may start a timer in response to a map command. The timer may count up to or count down from a value equal to a recovery point objective (RPO) of an application server, or a value equal to a maximum amount of time between rsync commands, as specified by an application. In some implementations, an application may specify an RPO. In some implementations, an RPO may be an attribute of a file stored at an address specified by a sync command.

Instructions 216 may generate an rsync command when the timer reaches a predetermined value. In implementations where the timer counts down, the predetermined value may be zero. In implementations where the timer counts up, the predetermined value may be a value equal to an RPO or a maximum amount of time between rsync commands.

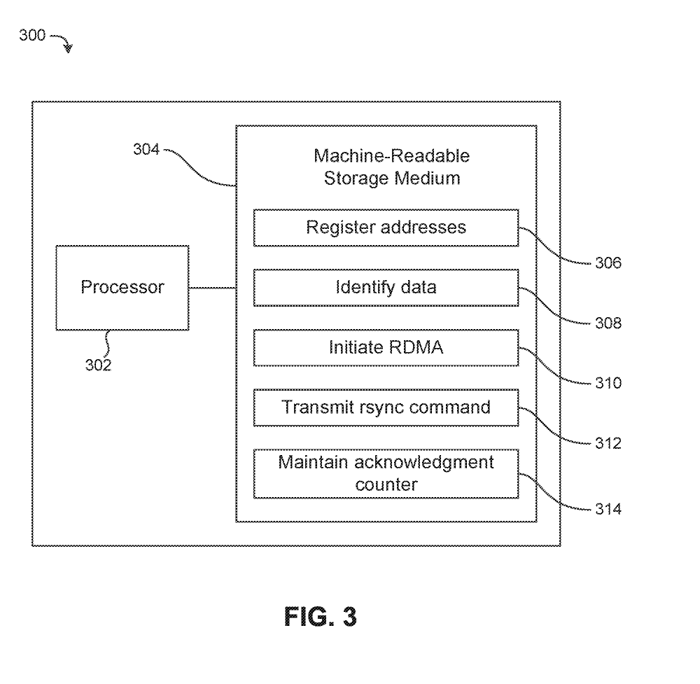

In some implementations, the generated rsync command may be transmitted to a remote storage entity using an RDMA, as discussed further below with respect to FIG. 3. Transmitting an rsync command using an RDMA may be referred to herein as transmitting an rsync command “in-band”. In some implementations, the generated rsync command may be transmitted “out-of-band” (i.e., without using an RDMA) to a remote storage entity. For example, an application may transmit the rsync command to a data service on the remote storage entity via normal communication channels controlled by CPUs on both sides. In response to receiving an rsync command, the data service may flush volatile caches/buffers of the remote storage entity to an NVM of the remote storage entity.

FIG. 3 is a block diagram of an example device 300 that includes a machine-readable storage medium encoded with instructions to enable tracking of completion of a remote synchronization of data. In some implementations, device 300 may operate as and/or be part of an application server. In FIG. 3, device 300 includes processor 302 and machine-readable storage medium 304.

As with processor 102 of FIG. 1, processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/ or execute instructions 306, 308, 310, 312, and 314 to enable tracking of completion of a remote synchronization of data, as described below. As an alternative or in addition to retrieving and/or executing instructions, processor 302 may include an electronic circuit comprising a number of electronic components for performing the functionality of instructions 306, 308, 310, 312, and/or 314,

As with machine-readable storage medium 104 of FIG. 1, machine-readable storage medium 304 may be any suitable physical storage device that stores executable instructions. Instructions 306, 308, and 310 on machine-readable storage medium 304 may be analogous to (e.g., have functions and/or components similar to) instructions 106, 108, and 110 on machine-readable storage medium 104. Instructions 312 may transmit, using an RDMA, an rsync command after a plurality of sync commands have been executed. In some implementations, the rsync command may be transmitted during an RDMA along with data to be replicated (i.e., data associated with the plurality of sync commands). In some implementations, a separate RDMA may be initiated specifically for transmitting the rsync command.

In some implementations, an application may periodically generate rsync commands to ensure that application consistency points are regularly reached. An rsync command may be generated in response to an unmap command issued by an application, if no rsync command has been issued since the last sync command was completed. An unmap command may cause pinned addresses on an application server and a remote storage entity to become un-pinned (e.g., an OS may modify/move data stored at such addresses).

Instructions 314 may maintain an acknowledgment counter to track completion of replication of data associated with a plurality of sync commands. The acknowledgment counter may be incremented each time a sync command is issued, and may be decremented as data associated with a sync command is replicated in a remote storage entity (e.g., as indicated by RDMA completion acknowledgments). An acknowledgment counter value of zero may indicate that execution of an rsync command (e.g., the rsync command in response to which data associated with the plurality of sync commands is replicated) has been completed.

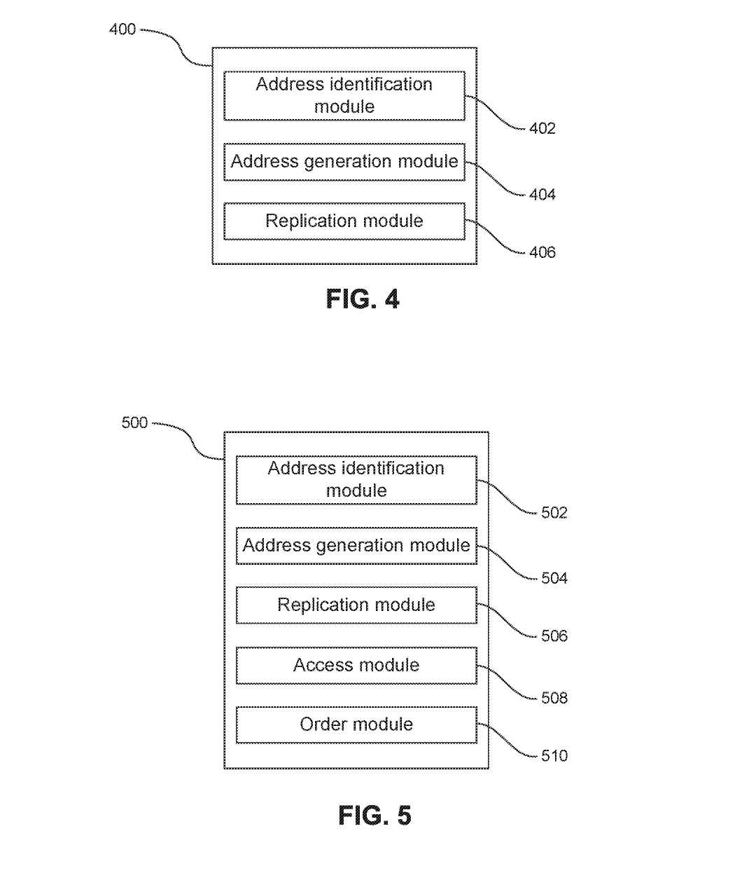

FIG. 4 is a block diagram of an example system 400 that enables registration of addresses in response to a map command. In some implementations, system 400 may operate as and/or be part of a remote storage entity. For example, system 400 may be implemented in a storage server that is communicatively coupled to an application server. Network adaptors may be used to communicatively couple the servers.

In FIG. 4, system 400 includes address identification module 402, address generation module 404, and replication module 406. A module may include a set of instructions encoded on a machine-readable storage medium and executable by a processor. In addition or as an alternative, a module may include a hardware device comprising electronic circuitry for implementing the functionality described below.

Address identification module 402 may identify, in response to a map command, a plurality of memory addresses in an NVM. The map command may include a first plurality of virtual addresses. The map command may be issued by an application running on an application server, and the NVM in which the plurality of memory addresses is identified may be on a storage server. Data associated with a plurality of sync commands, that specify any of the first plurality of virtual addresses, may be replicated in a region of the NVM that corresponds to the identified plurality of memory addresses. In some implementations, the NVM may be a memristor-based NVM. For example, the NVM may be a ReRAM.

Address generation module 404 may generate, in response to the map command, a second plurality of virtual addresses. Each of the second plurality of virtual addresses may be registered for RDMAs of the NVM, and may be associated with a respective one of the first plurality of virtual addresses. The second plurality of virtual addresses may be transmitted to the application server from which the map command was issued, and may be used to determine where in the NVM of the storage server to replicate data that is transferred using an RDMA. Each of the second plurality of virtual addresses may correspond to a respective one of the identified plurality of memory addresses in the NVM. The identified plurality of memory addresses in the NVM may be pinned, preventing an OS from moving or modifying data stored at such addresses while the second plurality of virtual addresses are registered,

Replication module 406 may replicate, using an RDMA, and in response to an rsync command, data associated with a plurality of sync commands that specify any of the first plurality of virtual addresses. The data associated with the plurality of sync commands may be replicated in the NVM in accordance with boundary indications in the plurality of sync commands. The boundary indications may be used to ensure that a remote copy of the data associated with the plurality of sync commands is identical to a local copy on the application server, as discussed above with respect to FIG. 1. In some implementations, the data associated with the plurality of sync commands may be replicated at memory addresses, of the identified plurality of memory addresses in the NVM, that correspond to respective ones of the second plurality of virtual addresses associated with respective ones of the first plurality of virtual addresses specified by the plurality of sync commands. In some implementations, replication module 406 may transmit a completion notification after the data associated with the plurality of sync commands has been replicated. The completion notification may indicate that an application consistency point has been reached.

FIG. 5 is a block diagram of an example system 500 for enforcing an order in which data is replicated in a remote storage entity. In some implementations, system 500 may operate as and/or be part of a remote storage entity. For example, system 500 may be implemented in a storage server that is communicatively coupled to an application server.

In FIG. 5, system 500 includes address identification module 502, address generation module 504, replication module 506, access module 508, and order module 510. A module may include a set of instructions encoded on a machine-readable storage medium and executable by a processor. In addition or as an alternative, a module may include a hardware device comprising electronic circuitry for implementing the functionality described below,

Modules 502, 504, and 506 of system 500 may be analogous to modules 402, 404, and 406, respectively, of system 400. Access module 508 may transmit an authentication token for an RDMA. The authentication token may be generated by a network adaptor on a remote storage entity and transmitted to an application server. In some implementations, the authentication token may be transmitted with the second plurality of virtual addresses that are generated by address generation module 504. The application server may use the authentication token to obtain authorization to transfer data using an RDMA.

Order module 510 may enforce an order in which a plurality of RDMAs are performed. In some implementations, it may be desirable to perform RDMAs in a particular order, for example when multiple RDMAs address the same memory locations in an NVM of a remote storage entity (which may happen if multiple sync commands specify the same virtual addresses). A sequence number may be assigned to and embedded in each RDMA. Order module 510 may maintain an order queue in the NVM of the remote storage entity. The order queue may buffer RDMAs having later sequence numbers until RDMAs having earlier sequence numbers have been completed.

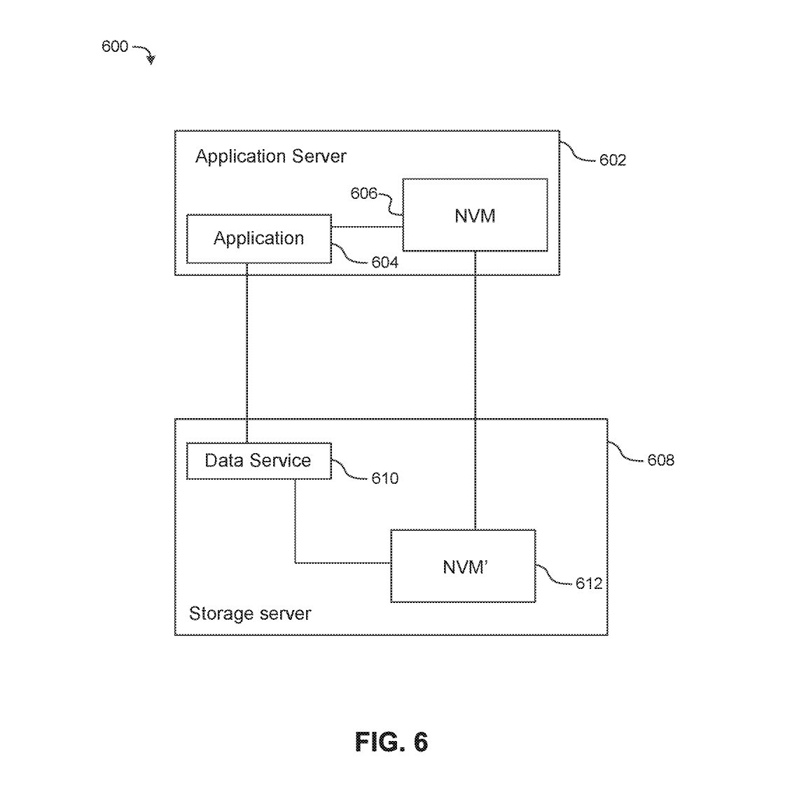

FIG. 6 is a block diagram of an example system 600 for remote synchronization of data. In FIG. 6, system 600 includes application server 602 and storage server 608. Application server 602 may include device 100, 200, or 300 of FIG. 1, 2, or 3, respectively. Storage server 608 may include system 400 or 500 of FIG. 4 or 5, respectively. Application 604 may run on application server 602, and may issue map commands, unmap commands, sync commands, and rsync commands. Data associated with sync commands issued by application 604 may be stored locally in NVM 606 of application server 602.

Storage server 608 may include data service 610 and NVM′ 612. Data service 610 may receive map commands and unmap commands issued by application 604. In some implementations, rsync commands may be transmitted out-of-band from application 604 to data service 610. In some implementations, rsync commands may be transmitted in-band from NVM 606 to NVM′ 612 using RDMAs, as discussed above with respect to FIG. 3. Data that is stored in NVM 606 may be transferred to and replicated in NVM 612 using RDMAs. Boundary indications in sync commands issued by application 604 may be used to ensure that a remote copy, in storage server 608, of the data associated with such sync commands is identical to a local copy on application server 602, as discussed above with respect to FIG. 1

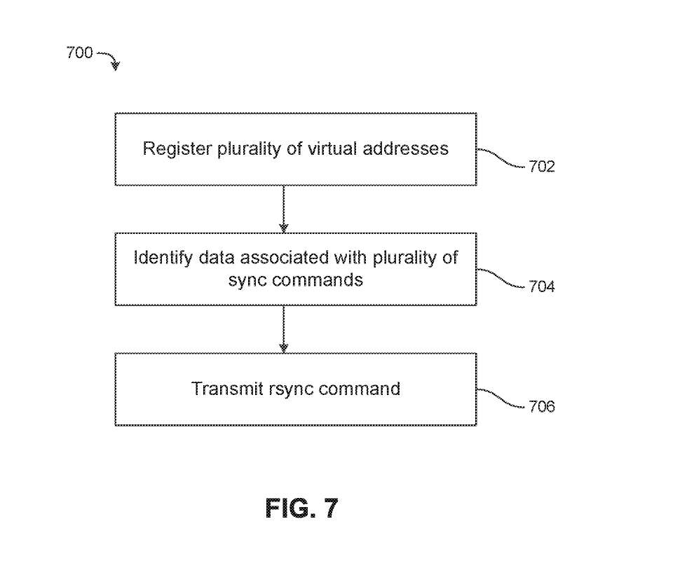

Methods related to using RDMA to synchronize data in remote locations are discussed with respect to FIGS. 7-9, FIG. 7 is a flowchart of an example method 700 for registering addresses for an RDMA. Although execution of method 700 is described below with reference to processor 302 of FIG. 3, it should be understood that execution of method 700 may be performed by other suitable devices, such as processors 102 and 202 of FIGS. 1 and 2, respectively, Method 700 may be implemented in the form of executable instructions stored on a machine-readable storage medium and/or in the form of electronic circuitry.

Method 700 may start in block 702, where processor 302 may register, in response to a map command, a plurality of virtual addresses specified by the map command. The registering of the plurality of virtual addresses may lead to the plurality of addresses being transmitted to a remote storage entity, which may generate another plurality of virtual addresses to be used for RDMAs of an NVM of the remote storage entity, as discussed above with respect to FIG. 1. Registered addresses may be pinned to prevent an OS from modifying or moving data stored at those addresses.

Next, in block 704, processor 302 may identify data associated with a plurality of sync commands that specify any of the plurality of virtual addresses. In some implementations, processor 302 may copy data associated with the plurality of sync commands to a data structure that is used to accumulate data to be replicated. In some implementations, processor 302 may set a replication bit of a page, in a page table, that includes data associated with any of the plurality of sync commands.

Finally, in block 706, processor 302 may transmit an rsync command to replicate, using an RDMA, the identified data in a remote storage entity. The identified data may be replicated in accordance with boundary indications in the plurality of sync commands. The boundary indications may be used to ensure that the identified data is grouped in the same way in the remote storage entity as in an NVM of an application server, as discussed above with respect to FIG. 1. In some implementations, the identified data may be replicated in a memristor-based NVM of the remote storage entity.

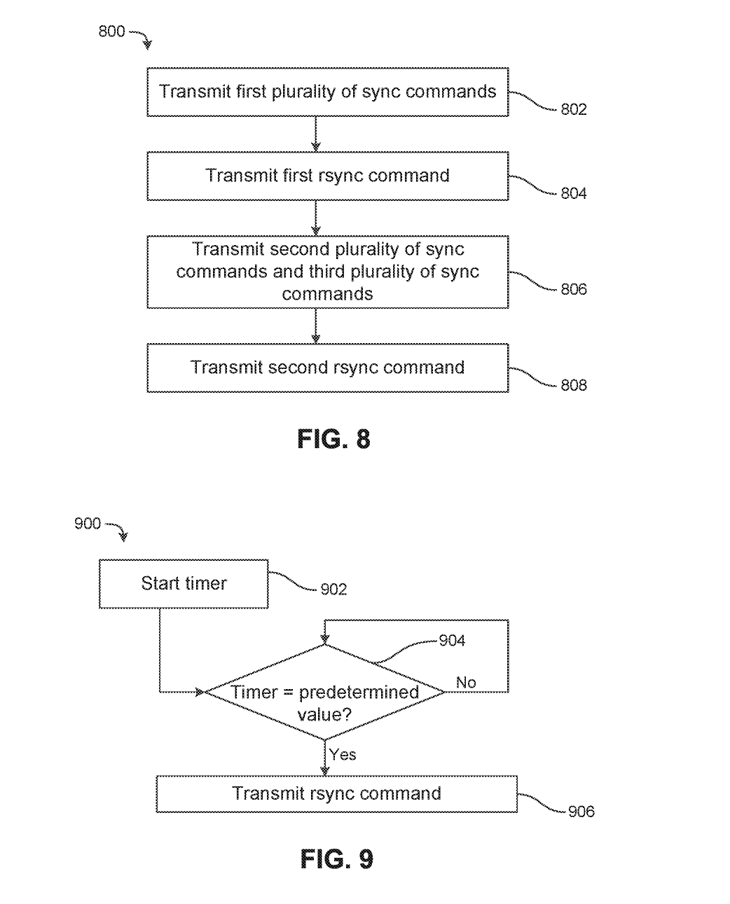

FIG. 8 is a flowchart of an example method 800 for replicating data in a remote storage entity. Although execution of method 800 is described below with reference to processor 302 of FIG. 3, it should be understood that execution of method 800 may be performed by other suitable devices, such as processors 102 and 202 of FIGS. 1 and 2, respectively. Some blocks of method 800 may be performed in parallel with and/or after method 700. Method 800 may be implemented in the form of executable instructions stored on a machine-readable storage medium and/or in the form of electronic circuitry,

Method 800 may start in block 802, where processor 302 may transmit a first plurality of sync commands. In response to the first plurality of sync commands, data associated with the first plurality of sync commands may be stored in an NVM of an application server. Data associated with the first plurality of sync commands may also be copied to a data structure or identified with a replication bit, as discussed above with respect to FIG. 1.

Next, in block 804, processor 302 may transmit a first rsync command. In some implementations, the first rsync command may be transmitted, using an RDMA, after the first plurality of sync commands have been executed. In some implementations, the first rsync command may be transmitted out-of-band. In response to the first rsync command, data associated with the first plurality of sync commands may be transferred to and replicated in a remote storage entity using an RDMA.

In block 806, processor 302 may transmit a second plurality of sync commands and a third plurality of sync commands after the first rsync command is transmitted and before a second rsync command is transmitted. Data associated with the second plurality of sync commands may be replicated in the remote storage entity using RDMAs that occur after the first rsync command is transmitted and before the second rsync command is transmitted. Data associated with the third plurality of sync commands may be copied to a data structure or identified with a replication bit, while data associated with the second plurality of sync commands may not be copied to a data structure or identified with a replication bit.

In block 808, processor 302 may transmit the second rsync command. Data associated with the third plurality of sync commands may be replicated in the remote storage entity using RDMAs that occur after the second rsync command is transmitted. Data associated with the third plurality of sync commands may be transferred to the remote storage entity after the second rsync command is transmitted. Data associated with the second plurality of sync commands may not be transferred to the remote storage entity after the second rsync command is transmitted, having already been transferred before the second rsync command was transmitted,

FIG. 9 is a flowchart of an example method 900 for enforcing a recovery point objective. Although execution of method 900 is described below with reference to processor 202 of FIG. 2, it should be understood that execution of method 900 may be performed by other suitable devices, such as processors 102 and 302 of FIGS. 1 and 3, respectively. Some blocks of method 900 may be performed in parallel with and/or after methods 700 and/or 800. Method 900 may be implemented in the form of executable instructions stored on a machine-readable storage medium and/or in the form of electronic circuitry.

Method 900 may start in block 902, where processor 202 may start a timer in response to a map command. The timer may count up to or count down from a value equal to an RPO of an application server, or a value equal to a maximum amount of time between rsync commands, as specified by an application. In some implementations, an application may specify an RPO. In some implementations, an RPO may be an attribute of a file stored at an address specified by a sync command.

In block 904, processor 202 may determine whether the timer has reached a predetermined value. In implementations where the timer counts down, the predetermined value may be zero. In implementations where the timer counts up, the predetermined value may be a value equal to an RPO or a maximum amount of time between rsync commands. If, in block 904, processor 202 determines that the timer has not reached the predetermined value, method 900 may loop back to block 904. If, in block 904, processor 202 determines that the timer has reached the predetermined value, method 900 may proceed to block 906, in which processor 202 may transmit an rsync command. The rsync command may be transmitted in-band or out-of-band to a remote storage entity,

The foregoing disclosure describes using information in map commands and sync commands for RDMA registration and data transfer. Example implementations described herein enable reduction of RDMA latency times and number of RDMAs used to transfer data to a remote storage entity.

I claim:

1. A machine-readable storage medium encoded with instructions executable by a processor, the machine-readable storage medium comprising:
instructions to register, in response to a map command, a first plurality of virtual addresses specified by the map command;
instructions to identify data associated with a plurality of synchronization (sync) commands that specify any of the first plurality of virtual addresses; and
instructions to initiate, in response to a remote synchronization (rsync) command, a remote direct memory access (RDMA) to replicate, in accordance with boundary indications in the plurality of sync commands, the identified data in a remote storage entity.

2. The machine-readable storage medium of claim 1, further comprising instructions to associate each of a second plurality of virtual addresses with a respective one of the first plurality of virtual addresses, wherein the identified data is replicated in memory locations, of the remote storage entity, that correspond to respective ones of the second plurality of virtual addresses associated with respective ones of the first plurality of virtual addresses specified by the plurality of sync commands.

3. The machine-readable storage medium of claim 1, wherein the identified data is replicated in a memristor-based non-volatile memory (NVM) of the remote storage entity.

4. The machine-readable storage medium of claim 1, further comprising:
instructions to start a timer in response to the map command; and
instructions to generate the rsync command when the timer reaches a predetermined value.

5. The machine-readable storage medium of claim 1, further comprising instructions to transmit, using the RDMA, the rsync command after the plurality of sync commands have been executed.

6. The machine-readable storage medium of claim 1, further comprising instructions to maintain an acknowledgment counter to track completion of replication of data associated with the plurality of sync commands.

7. A system comprising:
an address identification module to identify, in response to a map command, a plurality of memory addresses in a non-volatile memory (NVM), wherein the map command comprises a first plurality of virtual addresses;
an address generation module to generate, in response to the map command, a second plurality of virtual addresses, wherein:
each of the second plurality of virtual addresses is registered for remote direct memory accesses (RDMAs) of the NVM, and is associated with a respective one of the first plurality of virtual addresses; and
each of the second plurality of virtual addresses corresponds to a respective one of the identified plurality of memory addresses in the NVM: and
a replication module to replicate, using an RDMA, and in response to a remote synchronization (rsync) command, data associated with a plurality of synchronization (sync) commands that specify any of the first plurality of virtual addresses,

8. The system of claim 7, wherein:
the data associated with the plurality of sync commands is replicated in the NVM in accordance with boundary indications in the plurality of sync commands; and
the data associated with the plurality of sync commands is replicated at memory addresses, of the identified plurality of memory addresses in the NVM, that correspond to respective ones of the second plurality of virtual addresses associated with respective ones of the first plurality of virtual addresses specified by the plurality of sync commands.

9. The system of claim 7, further comprising an access module to transmit an authentication token for the RDMA.

10. The system of claim 7, wherein:
the NVM is a memristor-based NVM; and
the replication module is further to transmit a completion notification after the data associated with the plurality of sync commands has been replicated.

11. The system of claim 7, further comprising an order module to enforce an order in which a plurality of RDMAs are performed.

12. A method comprising:
registering, in response to a map command, a first plurality of virtual addresses specified by the map command;
identifying data associated with a first plurality of synchronization (sync) commands that specify any of the first plurality of virtual addresses; and
transmitting a first remote synchronization (rsync) command to replicate, using a remote direct memory access (RDMA), the identified data in a remote storage entity, wherein the identified data is replicated in accordance with boundary indications in the first plurality of sync commands.

13. The method of claim 12, wherein the first rsync command is transmitted, using the RDMA, after the first plurality of sync commands have been executed.

14. The method of claim 12, further comprising:
transmitting a second plurality of sync commands and a third plurality of sync commands after the first rsync command is transmitted and before a second rsync command is transmitted, wherein data associated with the second plurality of sync commands is replicated in the remote storage entity using RDMAs that occur after the first rsync command is transmitted and before the second rsync command is transmitted; and
transmitting the second rsync command, wherein data associated with the third plurality of sync commands is replicated in the remote storage entity using RDMAs that occur after the second rsync command is transmitted.

15. The method of claim 12, wherein the identified data is replicated in a memristor-based non-volatile memory (NVM) of the remote storage entity, the method further comprising starting a timer in response to the map command, wherein the first rsync command is transmitted when the timer reaches a predetermined value.
